(19) United States
(12) Patent Application Publication
(10) Pub. No.: US 2025/0354273 A1
(43) Pub. Date: Nov. 20, 2025

(54) ALUMINUM-BASED CATHODES FOR LITHIUM SUPEROXIDE

(71) Applicant: UCHICAGO ARGONNE, LLC, Chicago, IL (US)

(72) Inventors: Larry A. Curtiss, Downers Grove, IL (US); Khalil Amine, Oakbrook, IL (US); Hsien-Hau Wang, Downers Grove, IL (US); Rachid Amine, Bolingbrook, IL (US); Moon Gyu Park, Westmont, IL (US)

(73) Assignee: UCHICAGO ARGONNE, LLC, Chicago, IL (US)

(21) Appl. No.: 18/669,327

(22) Filed: May 20, 2024

(51) Int. Cl. C25B 1/14; C25B 11/032; C25B 11/046; C25B 11/065; C25B 11/089; C25B 15/08

(52) U.S. Cl. CPC C25B 1/14; C25B 11/032; C25B 11/046; C25B 11/065; C25B 11/089; C25B 15/083

(57) ABSTRACT

A lithium oxygen electrochemical cell includes an anode that includes lithium metal, a porous oxygen cathode that includes a conductive carbon and aluminum, and an electrolyte.

### GOVERNMENT RIGHTS

This invention was made with government support under Contract No. DEAC02-06CH11357 awarded by the United States Department of Energy to UChicago Argonne, LLC, operator of Argonne National Laboratory. The government has certain rights in the invention.

### FIELD

The present technology is generally related to the production of lithium superoxide (LiO₂) which is free of other lithium-oxygen compounds.

### BACKGROUND

There has been a significant interest in lithium superoxide (LiO₂), due to recent research into lithium-oxygen batteries, and the possibility that lithium superoxide may be an intermediate in the formation of lithium peroxide in lithium air cells. The first step in the oxygen reduction reaction (ORR) in a lithium air cell has been speculated to be the reduction of O₂ to O₂⁻, through a one-electron transfer, which is followed by the reaction with a lithium cation to form LiO₂ (Eqs. 1 and 2):

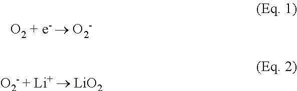

Lithium peroxide (Li₂O₂) can be then formed by the reaction of LiO₂ with Li⁺ through a second electron transfer, as shown in Eq. 3:

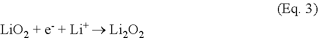

Alternatively, Li₂O₂ may be generated via the disproportionation reaction of LiO₂:

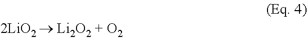

### SUMMARY

In one aspect, the present technology is based, in part, on the surprising discovery that lithium superoxide (LiO₂) can be prepared and stabilized at ambient temperature using the methods and compositions described herein.

Provided herein are methods and processes for the production of lithium superoxide (LiO₂), as well as compositions and electrochemical cells comprising lithium superoxide. The process(es) include: providing an electrochemical cell comprising a porous oxygen cathode, a lithium anode, a current collector, and an electrolyte; and discharging the electrochemical cell to form a discharge product; wherein: the porous oxygen cathode includes a composition that includes aluminum, and wherein the discharge product comprises LiO₂. In various embodiments, the composition may include lithium. In any such embodiment, the composition that is coated on the porous oxygen cathode includes LiAl.

In another aspect, a lithium oxygen electrochemical cell includes an anode including lithium metal, a porous oxygen cathode that includes aluminum, and an electrolyte. In some embodiments, the porous oxygen cathode includes LiAl. In such embodiments the electrochemical cell may be “an as-prepared device.” In other words, it is an electrochemical cell that is assembled and is in a state prior to the application of a first charging current or after a first discharge. Once the electrochemical cell has discharged and LiO₂ generated, the porous oxygen cathode may then also contain LiO₂.

In another aspect, a material may include both LiAl and LiO₂. In some embodiments, such a material may also contain a conductive carbon material.

### BRIEF DESCRIPTION OF THE DRAWINGS

FIG. 1 is a graph of Li—O₂ battery cycling performance of LiAl and rGO catalysts, LiAl/rGO with ionic liquid (EMIM-BF4) (red trace 1300 cycles), LiAl/rGO without ionic liquid (green trace 450 cycles), and rGO with ionic liquid (black trace 65 cycles), according to various embodiments.

FIG. 2 is an image of a synchrotron high-energy X-ray diffraction (HE-XRD) pattern of discharged LiAl/rGO cathode with and without the ionic liquid (EMIM-BF4), separator involving electrolyte with IL, and bare GDL, according to the examples.

FIG. 3A is a graph of UV-vis measurements of discharged cathodes with various Li—O₂ battery discharge capacities and FIG. 3B is a calibration curve for Li₂O₂ in TiOSO₄ base solution.

FIGS. 4A-B includes scanning electron microscopy (SEM) images of LiAl catalyst on 4A pristine LiAl/rGO cathode and 4B discharged LiAl/rGO cathode.

FIG. 5A illustrates the corresponding UV-vis peak intensity reductions by increased discharge capacity, and FIG. 5B the UV-vis peaks of various sample soaked in IC/DMSO solution pristine LiAl/rGO cathode, electrolyte, Li₂O₂, LiOH, Li₂CO₃, from top to bottom, according to the Examples.

FIGS. 6A-D illustrate (FIGS. 6A and 6B) LiO₂ (111) and LiIr₃ (121) surfaces with labelled Li—Li distances in Å, respectively, and (FIGs. C and 6D) LiO₂ (101) and LiAl (001) with labelled Li—Li distances, respectively with Li, Ir, Oxygen, and Al as labelled, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As utilized herein with respect to numerical ranges, the terms “approximately,” “about,” “substantially,” and similar terms will be understood by persons of ordinary skill in the art and will vary to some extent depending upon the context in which it is used. If there are uses of the terms that are not clear to persons of ordinary skill in the art, given the context in which it is used, the terms will be plus or minus 10% of the disclosed values. When “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the phrase “free of” or “substantially free of” means that in the compositions, the Li₂O₂ and/or the Li₂O are undetectable using spectroscopic methods. For example, “free of” or “substantially free of” may mean greater than 98% purity of the LiO₂, greater than 99% purity of the LiO₂, or greater than 99.9% purity of the LiO₂. In some embodiments, “free of” or “substantially free of” may mean 100% purity of the LiO₂.

As used herein, the term “ionic liquid” refers to any material that is a salt having an organic-based cationic group and an anion, and which is a liquid at the operating temperature. In many embodiments, the operating temperature is at or near room temperature. Illustrative ionic liquids are provided herein.

Lithium oxygen (Li—O₂) batteries have attracted extensive research interest due to their high energy density. Iridium (Ir)-based materials including IrLi and Ir₃Li have been studied as efficient electrocatalysts in Li—O₂ batteries.^{1,2} The surface lattices of IrLi and Ir₃Li catalysts are well-matched with lithium superoxide (LiO₂) surfaces and support epitaxial growth of LiO₂, resulting in reduced charge potentials and give longer cycle life. However, Ir is one of the most expensive precious metals, and its use would significantly increase the total cost of the Li—O₂ battery systems. Compared to lithium peroxide (Li₂O₂), LiO₂ has better charge transport (lower charge transport resistance) due to its good electronic conductivity, which leads to the lower charge potential and potentially longer cycle life of Li—O₂ batteries.³ Therefore, it is highly desirable to develop non-precious-metal-based electrocatalysts that can support the epitaxial growth of LiO₂.

Current lithium-oxygen (Li—O₂) batteries suffer from large charge overpotentials related to electronic resistivity of the insulating lithium peroxide (Li₂O₂) discharge product. One potential solution to this challenge is the stabilization of the lithium superoxide (LiO₂) discharge intermediate, which has much higher electronic conductivity compared to Li₂O₂. Cathodes based on iridium (Ir) nanoparticles, or Ir₃Li have been recently used in Li—O₂ batteries to successfully stabilize the LiO₂ product, however, the LiO₂ had a short lifetime, and the inclusion of the iridium is expensive. Accordingly, there is a need for developing new methods for the preparation and/or stabilization of lithium superoxide (LiO₂), as well as compositions comprising the stabilized lithium superoxide (LiO₂) and use thereof.

The present disclosure provides electrochemical cells and processes for forming lithium superoxide (LiO₂), as well as compositions and/or electrochemical cells comprising the resulting lithium superoxide (LiO₂). The lithium superoxide (LiO₂) described herein can be free of other lithium-oxygen compounds.

In one aspect, provided herein is a process of forming lithium superoxide (LiO₂) using an electrochemical cell. For example, the process may comprise: providing an electrochemical cell, and discharging the electrochemical cell to form a discharge product (e.g., a discharge product comprising LiO₂). In some embodiments, the electrochemical cell comprises a porous oxygen cathode (e.g., a porous oxygen carbon cathode), a lithium anode, a current collector, and an electrolyte. In some embodiments, the porous oxygen cathode comprises a gas-diffusion layer coated with a mixture of a porous conductive carbon and a material that includes aluminum. The gas-diffusion layer may be a gas diffusion paper used in oxygen electrochemical cells.

As noted above, the discharge product may include LiO₂. The LiO₂ produced in the method may be crystalline LiO₂, amorphous LiO₂, or a mixture thereof. The discharging may be conducted at a current of from about 10 mA/g to about 500 mA/g, and a capacity of from about 100 mAh/g to about 6000 mAh/g. The discharging may be conducted in the presence of O₂. The discharging may further include cycling of the electrochemical cell, i.e. discharging and charging cycles.

In addition to the aluminum, the composition may also include lithium. For example, in some embodiments, the composition includes a LiAl alloy. In such materials, the LiAl may have a lithium:aluminum ratio of about 1:9 to 9:1 on a mol basis. This may include an lithium:aluminum ratio of about 1:2 to 2:1 on a mol basis, or about 1:5 to about 1:2 on a mol basis. In some embodiments, the composition contains aluminum alone. In various embodiments, a loading of the composition onto the porous oxygen cathode is from about 0.1 mg/cm² to about 1.0 mg/cm².

The porous oxygen cathode may also include a porous conductive carbon. Illustrative porous conductive carbon materials include synthetic graphite, natural graphite, expanded graphite, graphene, reduced graphene oxide, a metal-organic framework, amorphous carbon, hard carbon, soft carbon, carbon black, acetylene black, carbon spheres, mesocarbon microbeads (MCMB), mesoporous carbon, porous carbon matrix, carbon nanofiber, carbon aerogel, single-walled carbon nanotube, multi-walled carbon nanotubes, carbon nanotube arrays, or a mixture of any two or more thereof. Commercial examples of carbon black include, but are not limited to, Super P, Black Pearls® 2000, Denka Black, Vulcan XC72R, and Ketjen Black®. In some embodiments, the porous conductive carbon includes graphene oxide or reduced graphene oxide (rGO). In some embodiments where the composition includes LiAl and a porous conductive carbon, a mass ratio of the porous conductive carbon:LiAl may be from about 1:1 to about 1:0.00005, or it may be about 1:1. In some embodiments, the porous oxygen cathode includes rGO and LiAl.

The LiAl may be present in the composition as particles on the nanometer or micrometer scale. For example, in some embodiments, the LiAl may include LiAl particles having a particle size of about 1 nm to about 10 μm in their largest dimension. This may include particles having a particle size of about 1 nm to about 500 nm.

As noted above, the electrochemical cell includes an electrolyte. The electrolytes include a lithium salt to support electron transport, and a solvent. In addition, other, stabilizing additive may be present in the electrolyte. The solvent may be an aprotic solvent such as an ether-based solvent, a fluorinated ether-based solvent, an oligo (ethylene oxide) solvent, an ionic liquid, or a mixture of any two or more thereof. Suitable solvents include, but are not limited to, ionic liquids, glyme, diglyme, tetrahydrofuran, tetraethyletheylene glycol dimethylether, tri(ethylene glycol)-substituted methyltrimethyl silane (1NM3), ethylene glycol-substituted methyltrimethyl silane (1NM1), and di(ethylene glycol)-substituted methyltrimethyl silane (1NM2). Other suitable solvents include, but are not limited to, acetonitrile (ACN), dimethyl sulfoxide (DMSO), dimethylformamide (DMF), triethyl phosphate, N,N-dimethylacetamide (DMA), N-methyl pyrrolidone (NMP), methoxybenzene, and siloxanes.

In some embodiments, the solvent is or includes an ionic liquid. As illustrated in the examples, the ionic liquids may reduce the charge overpotential and enhance the cycle life of electrolyte cells that incorporate the material. While not necessary, in some embodiments, the electrolyte includes the ionic liquid. In some embodiments, the ionic liquid includes a pyrrolidinium-based ionic liquid, a piperidinium-based ionic liquid, a imidazolium-based ionic liquid, a ammonium-based ionic liquid, a phosphonium-based ionic liquid, a cyclic phosphonium-based ionic liquid, or a sulfonium-based ionic liquid. In some specific embodiments, illustrative ionic liquids include, but are not limited to 1-ethyl-3-methyl-imidazolium bis(trifluoromethanesulfonyl)imide, 1-ethyl-3-methyl-imidazolium bis(fluorosulfonyl)imide, 1-ethyl-2,3-dimethyl-imidazolium bis(trifluoromethanesulfonyl)imide, 1-ethyl-2,3-dimethyl-imidazolium bis(fluorosulfonyl)imide, 1-methyl-3-ethyl-imidazolium bis(trifluoromethanesulfonyl)imide, 1-methyl-3-ethyl-imidazolium bis(fluorosulfonyl)imide, 1-ethyl-3-(2-methoxyethoxymethyl)-1H-imidazol-3-ium bis(trifluoromethanesulfonyl)imide, 1-ethyl-3-(2-methoxyethoxymethyl)-1H-imidazol-3-ium bis(fluorosulfonyl)imide, 1-n-butyl-3-methyl-imidazolium bis(trifluoromethanesulfonyl)imide, 1-n-butyl-3-methyl-imidazolium bis(fluorosulfonyl)imide, 3-ethyl-1-(2-methoxyethyl)-1H-imidazol-3-ium bis(trifluoromethanesulfonyl)imide, 3-ethyl-1-(2-methoxyethyl)-1H-imidazol-3-ium bis(fluorosulfonyl)imide, 1-butyl-1-methylpyrrolidinium bis(trifluoromethanesulfonyl)imide, 1-butyl-1-methylpyrrolidinium bis(fluorosulfonyl)imide, 1-ethyl-1-methylpyrrolidinium bis(trifluoromethanesulfonyl)imide, 1-ethyl-1-methylpyrrolidinium bis(fluorosulfonyl)imide, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-ethylpyrrolidinium bis(trifluoromethanesulfonyl)imide, 1-(2-methoxyethyl)-1-ethylpyrrolidinium bis(fluorosulfonyl)imide; piperidinium salts such as 1-butyl-1-methylpiperidinium bis(trifluoromethanesulfonyl)imide, 1-butyl-1-methylpiperidinium bis(fluorosulfonyl)imide, 1-methyl-1-propyl piperidinium bis(trifluoromethanesulfonyl)imide, 1-methyl-1-propyl piperidinium bis(fluorosulfonyl)imide, 1-(2-methoxyethyl)-1-ethylpiperidinium bis(trifluoromethanesulfonyl)imide, 1-(2-methoxyethyl)-1-ethylpiperidinium bis(fluorosulfonyl)imide, triethyl(2-methoxyethyl)phosphonium bis(trifluoromethanesulfonyl)imide, triethyl(2-methoxyethyl)phosphonium bis(fluorosulfonyl)imide, tripropyl(2-methoxyethyl)phosphonium bis(trifluoromethanesulfonyl)imide, tripropyl(2-methoxyethyl)phosphonium bis(fluorosulfonyl)imide, tributyl(2-methoxyethyl)phosphonium bis(trifluoromethanesulfonyl)imide, tributyl(2-methoxyethyl)phosphonium bis(fluorosulfonyl)imide, tetraethylphosphonium bis(trifluoromethanesulfonyl)imide, tetraethylphosphonium bis(fluorosulfonyl)imide, tetrabutylphosphonium bis(trifluoromethanesulfonyl)imide, tetrabutylphosphonium bis(fluorosulfonyl)imide, tributylmethylphosphonium bis(trifluoromethanesulfonyl)imide, tributylmethylphosphonium bis(fluorosulfonyl)imide, triethylbutylphosphonium bis(trifluoromethanesulfonyl)imide, triethylbutylphosphonium bis(fluorosulfonyl)imide, or a mixture of any two or more thereof.

In some embodiments, the ionic liquid comprises a salt having an anion and a cation, wherein the cation is N-methyl-N-propylpyrrolidinium, N-methyl-N-butylpyrrolidinium, 1-ethyl-3-methylimidazolium, 1-methoxyethyl-3-methylpyrrolidinium, or a mixture of any two or more thereof, and the anion is bis(fluorosulfonyl)imide, bis(trifluoromethane)sulfonimide, hexafluorophospate, tetrafluroborate, or a mixture of any two or more thereof.

As also noted above, the electrolyte also includes a lithium salt. Illustrative lithium salts include, but are not limited to, LiCF₃CO₂, LiC₂FsCO₂, LiClO₄, LiBF₄, LiAsF₆, LiPF₆, LiPF₂(C₂O₄)₂, LiPF₄C₂O₄, LiCF₃SO₃, LiN(CF₃SO₂)₂, LiC(CF₃SO₂)₃, LiN(SO₂C₂F₅)₂), lithium alkyl fluorophosphates, Li(C₂O₄)₂, LiBF₂C₂O₄, Li₂B₁₂X₁₂₋ₚHₚ, Li₂B₁₀X_{10-y}H_{y}, or any combination of two or more thereof, where X is OH, F, Cl, or Br; p is 0, 1, 2, 3, 4, 5, 6, 7, 8, 9, 10, 11, or 12; and y is 0, 1, 2, 3, 4, 5, 6, 7, 8, 9, or 10.

In addition to the processes described above for forming a discharge product (i.e. LiO₂), also provided are the devices as described above for use in the processes.

The electrochemical cells described herein may be cycled for a predetermined time, and at a predetermined capacity and current density. For example, a single cycle of the cell may be conducted for greater than 1 hour. In some embodiments, the cycle is conducted for from 1 hour to 48 hours, including from 2 hours to 24 hours, including from 12 hours to 24 hours, including 1 hour, 3 hours, 6 hours, 9 hours, 12 hours, 15 hours, 18 hours, 21 hours, or 24 hours, or any value therebetween. In some embodiments, the cycling (including the discharging) is conducted at a capacity of from about 100 mAh/g to about 2000 mAh/g, including about 100 mAh/g, about 200 mAh/g, about 300 mAh/g, about 400 mAh/g, about 500 mAh/g, about 600 mAh/g, about 700 mAh/g, about 800 mAh/g, about 900 mAh/g, about 1000 mAh/g, about 1100 mAh/g, about 1200 mAh/g, about 1300 mAh/g, about 1400 mAh/g, about 1500 mAh/g, about 1600 mAh/g, about 1700 mAh/g, about 1800 mAh/g, about 1900 mAh/g, or about 2000 mAh/g, or any value therebetween. In some embodiments, the cycling (including the discharging) is conducted at a current of from about 10 mA/h to about 500 mA/h, including about 10 mA/h, about 50 mA/h, about 100 mA/h, about 150 mA/h, about 200 mA/h, about 250 mA/h, about 300 mA/h, about 350 mA/h, about 400 mA/h, about 450 mA/h, or about 500 mA/h, or any value therebetween.

In some embodiments, the discharge product comprises LiO₂. In some embodiments, the discharge product is substantially free of Li₂O and Li₂O₂. As noted above, “free of” indicates, at least in some embodiments, that the LiO₂ is spectroscopically pure. For example, as described herein, the discharge product can be characterized using Raman spectroscopy, titration, Ultraviolet-visible spectroscopy, and transmission electron microscopy (TEM) study.

The lithium superoxide produced here may find application in lithium air batteries, as a cathode material for a closed Li-air battery systems without need for a source of oxygen for the storage of oxygen, in solid form with low molecular weight, and as a lithium storage material to pre-lithiate high-energy anodes.

Compositions and/or Electrochemical Cells

In another aspect, provided herein is a composition comprising lithium superoxide (LiO₂), reduced graphene oxide (rGO), and LiAl. In any of the embodiments described herein, the composition may be substantially free of other lithium-oxygen compounds such as lithium peroxide (Li₂O₂) or lithium oxide (Li₂O). As noted above, “free of” indicates, at least in some embodiments, that the LiO₂ is spectroscopically pure. In some embodiments, a mass ratio of rGO:LiAl in the composition is from about 1:1 to about 1:0.00005, including about 1:1, about 1:0.1, about 1:0.001, about 1:0.0001, about 1:0.00005, or any value therebetween. In some embodiments, a mass ratio of rGO:LiAl in the composition is about 1:1.

The present invention, thus generally described, will be understood more readily by reference to the following examples, which are provided by way of illustration and are not intended to be limiting of the present invention.

### Examples

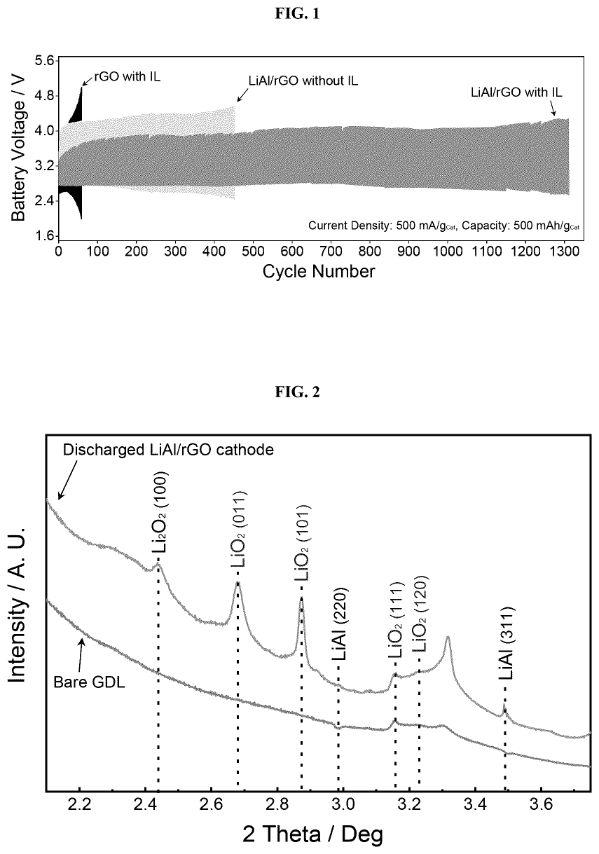

Example 1. Recently, using density functional theory (DFT) simulation, we have determined that LiAl has the potential to be a non-precious-metal electrocatalyst, as some of its surfaces have a good lattice match with LiO₂ that is similar to the matches found for Ir₃Li and IrLi. Herein we apply LiAl to Li—O₂ cells to study its electrocatalytic performance and its physicochemical properties. The cycling performance of Li—O₂ battery with LiAl catalyst is presented in FIG. 1. In comparison to reduced graphene oxide (rGO, also used as a conductive catalyst support) only catalysts, LiAl/rGO demonstrates improved electrocatalytic activity towards both oxygen reduction reactions (ORR) and oxygen evolution reactions (OER), for Li—O₂ battery discharge and charge, respectively.⁴ Furthermore, the use of an electrolyte composed of tetraglyme, lithium triflate, and an ionic liquid (e.g., 1-ethyl-3-methylimidazolium tetrafluoroborate (EMIM-BF₄)) achieves 1300 cycles in a Li—O₂ battery. Without the IL, the LiAl/rGO still displays good cyclability (460 cycles with a high cut-off voltage of 4.6 V), although the overpotential was much larger than that with ionic liquid. Specifically, the charge potential has been significantly reduced when using the ionic liquid, which illustrates that the ionic liquid probably protects the surface of LiAl that can be oxidized by O₂. It has been observed that the rGO without the LiAl catalyst, but with ionic liquid, shows poor cyclability demonstrating the favorable catalytic capability of LiAl in the Li—O₂ cell. In this context, it is demonstrated that the utilization of ionic liquid not only enhances cycle life, but also reduces the overpotential of a Li—O₂ battery.

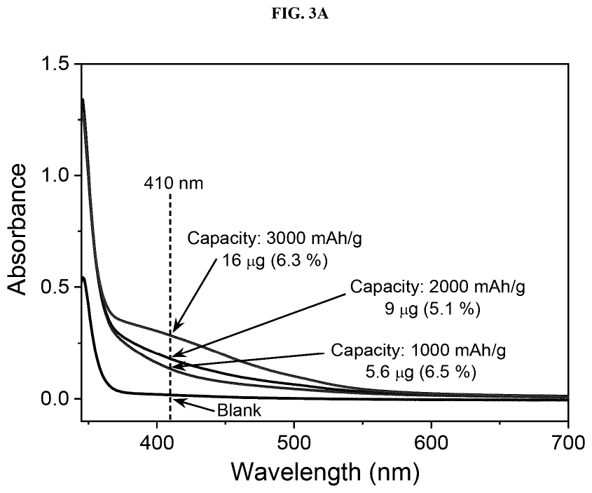

The Li—O₂ battery cycling performance using LiAl catalyst and ionic liquid exhibited lower charge potentials with prolonged cyclability. X-ray diffraction analysis for the Li—O₂ cell with and without the ionic liquid has been carried out to characterize the discharge product. As shown in FIG. 2, XRD patterns of the discharged LiAl/rGO cathodes (with and without ionic liquid) exhibit the two major peaks of LiO₂ (101 and 011) indicating that the LiAl based cathode results in LiO₂ formation.⁴ Additionally, a small peak for Li₂O₂ ((100) lattice) was obtained, indicating that LiAl favors formation of LiO₂ as the major discharge product over Li₂O₂.⁵ The results in FIG. 2 for the separator involving electrolyte with the ionic liquid also indicate the presence of LiO₂ in the discharge product, but the peaks are not nearly as strong.

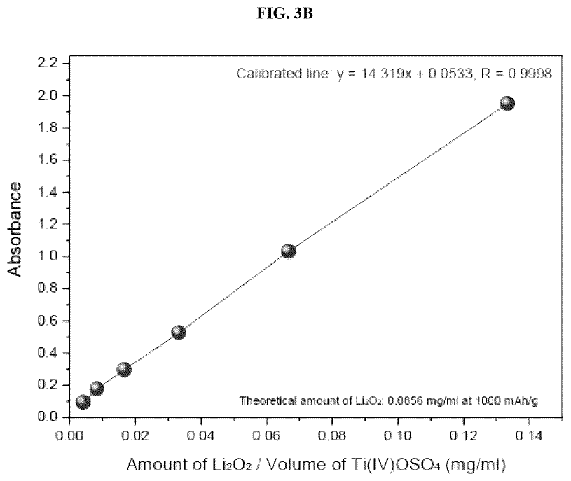

As shown in FIG. 3, an acid titration analysis has been conducted to measure the relative amount of Li₂O₂ in discharge products from the discharged cathodes.⁶ The reaction between an acid solution (TiOSO₄) and Li₂O₂ results in a color change to yellow or orange and some extent of UV absorption, which results from a formation of a titanium peroxide complex (TiO₂SO₄). The color change only occurs when Li₂O₂ exists on a discharged cathode. Based on the calibration line (FIG. 3b), the amount of Li₂O₂ from the discharged cathode can be quantitatively obtained and compared with the theoretical amount per discharge capacity. Different discharge capacities were applied to Li—O₂ cells and the obtained UV-vis peak intensities at 410 nm of wavelength were measured and compared with the theoretical amount of Li₂O₂(FIG. 3a). For capacities ranging from 1000 to 3000 mAh/g_{cat}, the amount of Li₂O₂ was only about 6%, with the other 94% presumably LiO₂ as the major discharge product, which is consistent with the HE-XRD results.

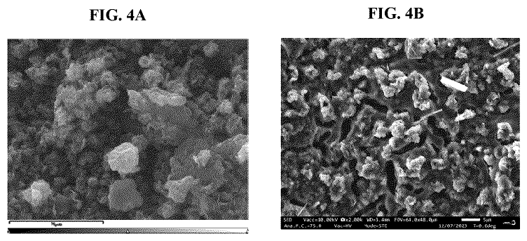

Scanning electron microscopy (SEM) has been utilized to investigate the morphology and elemental information of LiAl and discharge products as displayed in FIG. 4. Comparing the LiAl/rGO cathode surface before and after discharge, LiAl and rGO particles were clearly observed. However, no other specific morphology was obtained, such as the typical toroids of Li₂O₂.⁴ Energy dispersive X-ray spectroscopy (EDS) results in apparent differences between pristine and discharged cathodes (Figure is not provided). LiAl catalyst particle on the pristine cathode shows explicit elemental distribution of Al with a tiny amount of oxygen. However, when a LiAl particle from the discharged cathode is tested via EDS, the concentrated Al elemental distribution on the LiAl particle largely vanishes, and only a small portion of the Al is presented. This is presumably due to the lithium discharge product (e.g., LiO₂) covering the surface of LiAl.

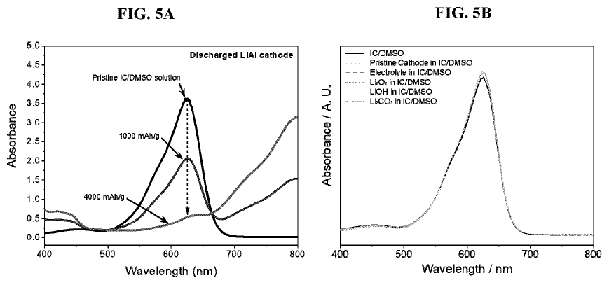

We have also found that it is possible to detect LiO₂ from a discharged cathode via a conversion reaction of indigo carmine (IC).⁷ It was found that superoxide reacts slowly with indigo carmine and converts it to isatin sulfonic acid. More specifically, blue colored indigo carmine reacts with the superoxide molecules to bleach and lighten the blue coloration. The degree of lightened color can be measured by UV-vis spectroscopy like the acid titration, the amount of LiO₂ could be quantitatively obtained. Accordingly, the discharged LiAl/rGO cathodes are immersed in indigo carmine dissolved in DMSO solution to investigate a color change primarily due to the reaction between LiO₂ and indigo carmine (FIG. 5). UV-vis peak intensity at 625 nm of wavelength is decreased with the raised discharge capacity (FIG. 5A). To explore a possibility of the indigo carmine reaction with other components of Li—O₂ batteries, pristine cathode, electrolyte, and possible lithium-based materials such as Li₂O₂, LiOH, and Li₂CO₃ were screened by soaking each sample into IC/DMSO solution (FIG. 5B). There was no color change observed and the corresponding UV-vis peak intensities did not vary as well, which demonstrates that the reaction and color bleaching only occurs between LiO₂ and indigo carmine. As a result, the indigo carmine conversion reaction shows that LiO₂ is present in the discharge product.

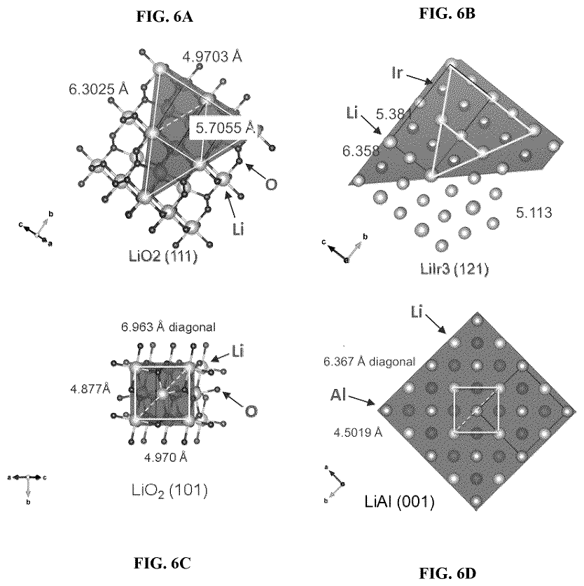

In FIGS. 6A and 6B, LiO₂ (111) and LiIr₃ (121) surfaces with labelled Li—Li distances in Å, and in FIGS. 6C and 6D, LiO₂ (101) and LiAl (001) with labelled Li—Li distances, respectively are shown. In the figures, the corresponding elements (sizes) are: Li (r: 155 pm), Ir (r: 136 pm), Oxygen (r: 73 pm), and Al (r: 143 pm) (pointed by arrows). As shown in FIGS. 6a and 6b, the LiIr₃ (121) surface has a very good lattice match with that of the LiO₂ (111) surface. This was reported previously based on DFT calculations.^{2,4,8} The good lattice match lowers the interfacial energy between the catalyst (LiIr₃) and discharge product (LiO₂) and may lead to epitaxial growth.⁹ A simple model is developed to quantitatively estimate how well the lattice of a LiMₓ (x is an integer) layer matches that of LiO₂. A rhombus unit cell is chosen for the 2D LiO₂ (111) plane as indicated in FIG. 6A. The individual Rₙ (n=1-3) factors (Equation 1) measure the difference of each unit cell length (l_{n′}) in Å over the unit cell length (lₙ) of LiO₂. The goodness of the fit R factor (Equation 2) combines the contribution from all three sides and represents how well the LiMₓ layer fits that of LiO₂. For example, the two sides and short diagonal lengths (dash line) of the unit cell for LiO₂ (111) plane are: l₁ 6.302 Å, l₂ 5.705 Å, and l₃ 4.970 Å, based on ICSD-180561 of a calculated LiO₂ structure. The equivalent experimental lengths for LiIr₃ (121) plane are: l_{1′}6.358 Å, l₂, 5.381 Å, and l₃, 5.113 Å, respectively, (ICSD-104488, FIG. 6b).

$${R}_{n} = \frac{{l}_{n} - {l}_{{n}^{′}}}{{l}_{n}} , n = 1 - 3 \qquad ( Eq . 1 )$$

$$R = √ ( {{R}_{1}}^{2} + {{R}_{2}}^{2} + {{R}_{3}}^{2} ) = 6.43 \% \qquad ( Eq . 2 )$$

The lower the value of the goodness of fit (R) the better the two lattices match and the R value for LiO₂ (111) plane over the LiIr₃ (121) plane is 6.4%. For the LiAl alloys, the most thermodynamically stable phase is the cubic phase (Fd3̅m ICSD-57950) and this is the phase observed from our XRD characterization (FIG. 2). As shown in FIGS. 6c and 6d, the LiAl (001) surface has a close match with that of the LiO₂ (101) surface. The goodness of fit R factor for LiO₂ (101) over LiAl (001) is calculated to be 14.9% that is well within the experimental upper limit (˜37% in La₂NiO₄₋₆) of a close lattice match. In addition, since LiAl is cubic in symmetry, all (100), (010), and (001) surfaces will allow the same epitaxial growth of the LiO₂. The simple template or lattice matching effect supports that LiAl is a good catalyst that triggers LiO₂ growth.

In summary, a very robust Li—O₂ battery with a Li-metal anode, Li-triflate/TEGDME/ionic liquid (such as EMIM-BF₄) electrolyte, and LiAl-rGO-GDL cathode can be prepared with the following properties:
The Li—O₂ batteries with the aforementioned components cycled electrochemically under oxygen more than 1300 times with an overpotential gap less than 1.6 V.
LiAl cubic phase is a robust catalyst for Li—O₂ cell. The discharge product is primarily (˜94%) LiO₂ with small amount (˜6%) of Li₂O₂.
The discharge products are characterized with use of titration including indigo carmine (for LiO₂), TiOSO₄ (for Li₂O₂), and HE-XRD. This is the first time that indigo carmine has been identified to be able to quantitatively characterize the LiO₂ discharge product.
The Li—O₂ battery system with use of ionic liquid such as but not limited to EMIM-BF₄ performs significantly better than without ionic liquid additive.

The excellent performance of the LiAl catalyst is consistent with the observed lattice match and/or template effect with LiO₂. The goodness of fit R factor can be used to identify and/or down select other potential Li—O₂ ORR and OER catalysts.
1. S. T. Plunkett, A. Kondori, D. Y. Chung, J. Wen, M. Wolfman, S. H. Lapidus, Y. Ren, R. Amine, K. Amine, A. U. Mane, M. Asadi, S. Al-Hallaj, B. P. Chaplin, K. C. Lau, H.-H. Wang and L. A. Curtiss, ACS Energy Lett., 2022, 7, 2619-2626.
2. S. T. Plunkett, C. Zhang, K. C. Lau, M. R. Kephart, J. G. Wen, D. Y. Chung, D. Phelan, Y. Ren, K. Amine, S. Al-Hallaj, B. P. Chaplin, H.-H. Wang and L. A. Curtiss, Nano Energy, 2021, 90, 106549.
3. S. T. Plunkett, H.-H. Wang, S. H. Park, Y. J. Lee, J. Cabana, K. Amine, S. Al-Hallaj, B. P. Chaplin and L. A. Curtiss, ACS Appl. Energy Mater., 2020, 3, 12575-12583.
4. J. Lu, Y. J. Lee, X. Luo, K. C. Lau, M. Asadi, H. H. Wang, S. Brombosz, J. Wen, D. Zhai, Z. Chen, D. J. Miller, Y. S. Jeong, J. B. Park, Z. Z. Fang, B. Kumar, A. Salehi-Khojin, Y. K. Sun, L. A. Curtiss and K. Amine, Nature, 2016, 529, 377-382.
5. A. Halder, H.-H. Wang, K. C. Lau, R. S. Assary, J. Lu, S. Vajda, K. Amine and L. A. Curtiss, ACS Energy Lett., 2018, 3, 1105-1109.
6. H.-H. Wang, Y. J. Lee, R. S. Assary, C. Zhang, X. Luo, P. C. Redfern, J. Lu, Y. J. Lee, D. H. Kim, T.-G. Kang, E. Indacochea, K. C. Lau, K. Amine and L. A. Curtiss, The J. Phys. Chem. C, 2017, 121, 9657-9661.
7. A. J. Kettle, B. M. Clark and C. C. Winterbourn, J. Biol. Chem., 2004, 279, 18521-18525.
8. A. Halder, A. T. Ngo, X. Luo, H. H. Wang, J. G. Wen, P. Abbasi, M. Asadi, C. Zhang, D. Miller, D. Zhang, J. Lu, P. C. Redfern, K. C. Lau, R. Amine, R. S. Assary, Y. J. Lee, A. Salehi-Khojin, S. Vajda, K. Amine and L. A. Curtiss, J. Phys. Chem. A, 2019, 123, 10047-10056.
9. H. H. Wang, C. Zhang, J. Gao, K. C. Lau, S. T. Plunkett, M. Park, R. Amine and L. A. Curtiss, Faraday Discuss., 2023, 248, 48-59.

While certain embodiments have been illustrated and described, it should be understood that changes and modifications can be made therein in accordance with ordinary skill in the art without departing from the technology in its broader aspects.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process of forming LiO₂, the process comprising:
providing an electrochemical cell comprising a porous oxygen cathode, a lithium anode, a current collector, and an electrolyte; and
discharging the electrochemical cell to form a discharge product;
wherein:
the porous oxygen cathode comprises a composition comprising aluminum;
the discharge product comprises the LiO₂.

2. The process of claim 1, wherein the composition further comprises lithium.

3. The process of claim 2, wherein the composition comprises LiAl.

4. The process of claim 3, wherein the LiAl has an lithium:aluminum ratio of about 1:9 to 9:1 on a mol basis.

5. The process of claim 3, wherein the LiAl has an lithium:aluminum ratio of about 1:2 to 2:1 on a mol basis.

6. The process of claim 3, wherein the lithium:aluminum ratio is about 1:5 to about 1:2.

7. The process of claim 1, wherein the porous oxygen cathode further comprises a porous conductive carbon.

8. The process of claim 7, wherein the porous conductive carbon comprises synthetic graphite, natural graphite, expanded graphite, graphene, reduced graphene oxide, a metal-organic framework, amorphous carbon, hard carbon, soft carbon, carbon black, acetylene black, carbon spheres, mesocarbon microbeads (MCMB), mesoporous carbon, porous carbon matrix, carbon nanofiber, carbon aerogel, single-walled carbon nanotube, multi-walled carbon nanotubes, carbon nanotube arrays, or a mixture of any two or more thereof.

9. The process of claim 8, wherein the porous conductive carbon comprises graphene oxide or reduced graphene oxide (rGO).

10. The process of claim 1, wherein the porous oxygen cathode comprises rGO and LiAl.

11. The process of claim 10, wherein the porous oxygen cathode comprises LiAl and a porous conductive carbon having a mass ratio of the porous conductive carbon:LiAl from about 1:1 to about 1:0.00005.

12. The process of claim 11, wherein the mass ratio of the porous conductive carbon:LiAl is about 1:1.

13. The process of claim 3, wherein the LiAl comprises LiAl particles having a particle size of about 1 nm to about 10 um.

14. The process of claim 1, wherein the LiO₂ is crystalline LiO₂, amorphous LiO₂, or a mixture thereof.

15. The process of claim 1, wherein a loading of the composition onto the porous oxygen cathode is from about 0.1 mg/cm² to about 1.0 mg/cm².

16. The process of claim 1, wherein the discharging is conducted at a current of from about 10 mA/g to about 500 mA/g, and a capacity of from about 100 mAh/g to about 6000 mAh/g.

17. The process of claim 1, wherein the electrolyte comprises an aprotic solvent and a lithium salt.

18. A lithium oxygen electrochemical cell comprising:
an anode comprising lithium metal;
a porous oxygen cathode comprising aluminum; and
an electrolyte.

19. The lithium oxygen electrochemical cell of claim 18, wherein the porous oxygen cathode comprises LiAl.

20. The lithium oxygen electrochem cell of claim 18, wherein the porous oxygen cathode comprises a discharge product comprising LiO₂.
